(19) United States
(12) Patent Application Publication
(10) Pub. No.: US 2017/0001427 A1
(43) Pub. Date: Jan. 5, 2017

(54) Electronic Devices With Moisture And Light Curable Adhesive

(71) Applicant: Apple Inc., Cupertino, CA (US)

(72) Inventors: James R. Krogdahl, Cupertino, CA (US); George Kyle Lobisser, Los Altos Hills, CA (US); Justin R. Wodrich, Saratoga, CA (US)

(21) Appl. No.: 14/790,932

(22) Filed: Jul. 2, 2015

(51) Int. Cl. B32B 38/10; B32B 37/12; B32B 37/06

(52) U.S. Cl. CPC B32B 38/10; B32B 37/06; B32B 37/12; B32B 2305/72

(57) ABSTRACT

An electronic device may include electronic device structures that are attached with a moisture and light curable adhesive. To assemble the electronic device, adhesive may be dispensed onto a first electronic device structure. An attachment structure may then be used to attach a second electronic device structure to the first electronic device structure. The electronic device may be tested with testing equipment. If the electronic device needs to be reworked, a separation tool may be used to separate the first and second electronic device structures. After separating the structures, residual moisture and light curable adhesive on the structures may be exposed to light to ensure that the moisture and light curable adhesive is fully cured. The moisture and light curable adhesive may then be removed without leaving any residue on the electronic device housing structures. The electronic device structures may include an electronic device housing and a cover glass.

### BACKGROUND

This relates generally to electronic devices, and more particularly, to joining electronic device structures using adhesive.

Adhesives are widely used to attach structures to each other. As an example, electronic devices such as computers and cellular telephones often contain adhesives for mounting components to housing structures, for attaching housing structures to each other, and for otherwise assembling structures within a completed device.

Faults are sometimes detected when manufacturing an electronic device. For example, a faulty component may be identified or an assembly operation may be performed imperfectly. In some situations, faults may be serious enough that a device must be scrapped. In other situations, it is possible to rework a device and thereby salvage unaffected components. During rework operations, a faulty component can be replaced with a defect-free component.

The ability to easily rework a device can often lead to substantial improvements in assembly efficiency. In contrast, a device design that is difficult to rework may result in the need to scrap an undesirably large number of devices.

To ensure that device structures are satisfactorily bonded together, liquid adhesive or adhesive tape is often used that can form strong adhesive bonds. To help disassemble parts that have been attached to each other using liquid adhesives and adhesive tapes, the adhesive can be heated. This reduces the adhesion and cohesive strength of the adhesive sufficiently so that the parts can be pulled apart. Unfortunately, tape that is pulled apart in this way tends to leave stubborn adhesive residues on the surfaces of the disassembled parts. Before the parts can be reworked, physical effort or solvents must be used to remove the adhesive residues. The use of physical effort or solvents to clean the surface of the parts can be time consuming and messy.

It would therefore be desirable to be able to provide improved adhesives that facilitate rework operations during electronic device assembly.

### SUMMARY

A system may be used to assemble electronic devices. The system may include an adhesive application tool, an attachment tool, testing equipment, a separation tool, a light source, an adhesive removal tool, and other processing equipment. The system may be used to attach electronic device structures together using moisture and light curable adhesive. For example, a display cover layer may be attached to a device housing using moisture and light curable adhesive or other electronic device structures may be adhered to each other using moisture and UV/visible light curable adhesive.

The moisture and UV/visible light curable adhesive may be isolated from ambient moisture and light until the adhesive is dispensed. Once dispensed, the adhesive may be exposed to ambient moisture in the air. The exposure to ambient moisture may begin curing the moisture and UV/visible light curable adhesive. However, the adhesive may not be fully cured until one to three days after the adhesive is dispensed.

After the system dispenses the adhesive and attaches the electronic device structures together with the adhesive, the electronic device may be tested using testing equipment. The testing equipment may identify a fault in the electronic device. In these scenarios, the electronic device may be reworked to salvage the properly functioning components of the electronic device.

In order to rework the electronic device, the adhesive may be debonded by localized application of heat and the electronic device structures may be pulled apart. The adhesive may then be removed. It may be desirable for the adhesive to be fully cured in order to facilitate a clean removal of the adhesive. If the adhesive is not fully cured, adhesive residue may be left on the surfaces of the disassembled electronic device structures. For the electronic device structures to be salvaged, solvents may need to be used to remove the adhesive residues. However, if the adhesive is fully cured before removal, the adhesive may peel away from the electronic device structures in a controlled manner without leaving any residue.

To ensure that the adhesive is fully cured before the adhesive is removed from the electronic device structures, the adhesive may be exposed to a radiation source such as ultraviolet or visible light. This may be particularly advantageous in situations where the electronic device needs to be reworked soon after application of the adhesive, before it has had time to moisture cure. In these scenarios, the adhesive may not yet be fully cured by exposure to moisture, which takes several days. Exposing the adhesive to UV/visible light will cure the adhesive, increasing the cohesive strength, and ensure no residue is left on the electronic device structures during removal.

### BRIEF DESCRIPTION OF THE DRAWINGS

FIG. 1 is a perspective view of an illustrative electronic device such as a laptop computer with structures that are attached using moisture and light curable adhesive in accordance with an embodiment.

FIG. 2 is a perspective view of an illustrative electronic device such as a handheld electronic device with structures that are attached using moisture and light curable adhesive in accordance with an embodiment.

FIG. 3 is a perspective view of an illustrative electronic device such as a tablet computer with structures that are attached using moisture and light curable adhesive in accordance with an embodiment.

FIG. 4 is a perspective view of an illustrative electronic device such as a computer or television with structures that are attached using moisture and light curable adhesive in accordance with an embodiment.

FIG. 5 is a perspective view of an illustrative electronic device with structures that are attached using moisture and light curable adhesive in accordance with an embodiment.

FIG. 6 is a cross-sectional side view of an illustrative electronic device with structures that are attached using moisture and light curable adhesive in accordance with an embodiment.

FIG. 7 is a diagram of an illustrative system for processing an electronic device that has electronic device structures attached with moisture and light curable adhesive in accordance with an embodiment.

FIG. 8 is a cross-sectional side view of an illustrative attachment tool for attaching electronic device structures using moisture and light curable adhesive in accordance with an embodiment.

FIG. 9 is a cross-sectional side view of an illustrative separation tool for separating electronic device structures in accordance with an embodiment.

FIG. 10 is a side view of an illustrative light source with a computer-controlled positioner for exposing moisture and light curable adhesive on an electronic device structure to light in accordance with an embodiment.

FIG. 11 is a side view of an illustrative light source with a light guide for exposing moisture and light curable adhesive on an electronic device structure to light in accordance with an embodiment.

FIG. 12 is a side view of an illustrative light source for exposing moisture and light curable adhesive on an electronic device structure to light in accordance with an embodiment.

FIGS. 13A and 13B are diagrams showing how an electronic device with electronic device structures attached using moisture and light curable adhesive may be processed in accordance with an embodiment.

FIG. 14 is a flowchart showing illustrative steps involved with processing an electronic device that includes electronic device structures attached with moisture and light curable adhesive in accordance with an embodiment.

### DETAILED DESCRIPTION

Electronic devices such as cellular telephones, tablet computers, laptop computers, desktop computers, computers integrated into computer monitors, televisions, media players, portable devices, and other electronic equipment may include electronic device structures that are attached with adhesive. Electronic device structures that are attached with adhesive may include electronic device housings and cover glasses. The adhesive used to attach electronic devices structures in an electronic device may be a moisture and UV/visible light cured adhesive.

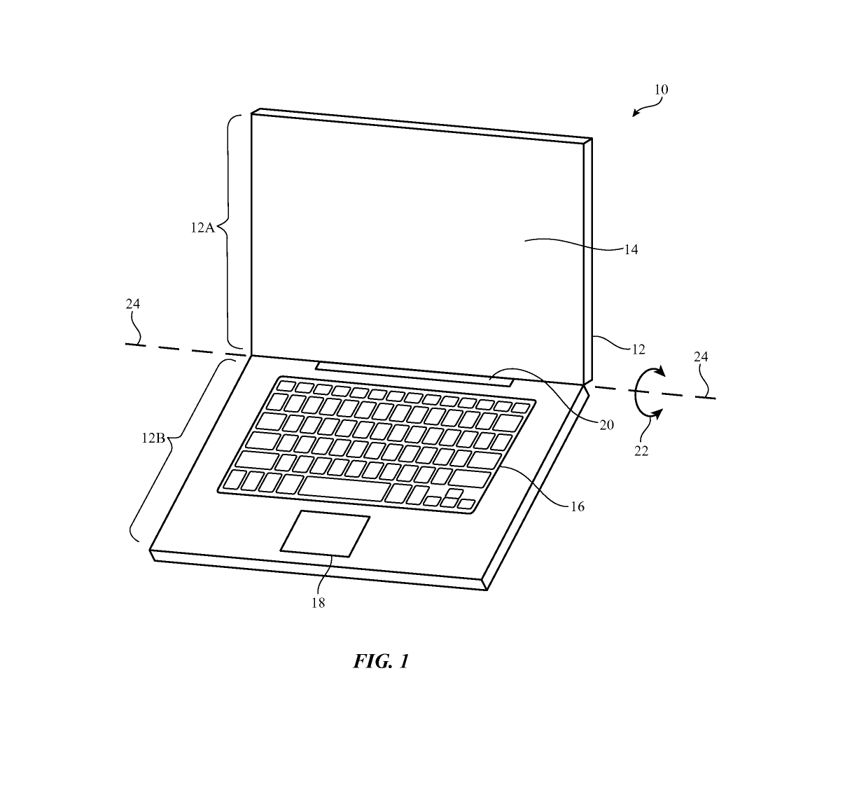

Illustrative electronic devices of the types that may be provided with structures that are joined using moisture and UV/visible light curable adhesive are shown in FIGS. 1, 2, 3, 4, and 5.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

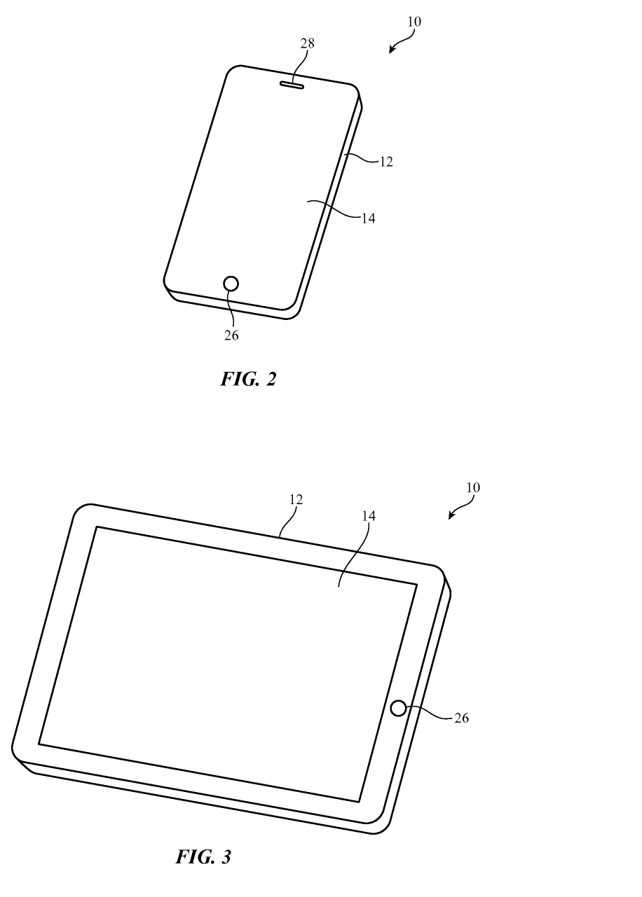

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.). Display 14 may be protected using a display cover layer such as a layer of transparent glass or clear plastic. Openings may be formed in the display cover layer. For example, an opening may be formed in the display cover layer to accommodate a button such as button 26. An opening may also be formed in the display cover layer to accommodate ports such as speaker port 28. Openings may be formed in housing 12 to form communications ports, holes for buttons, and other structures.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an opening to accommodate button 26.

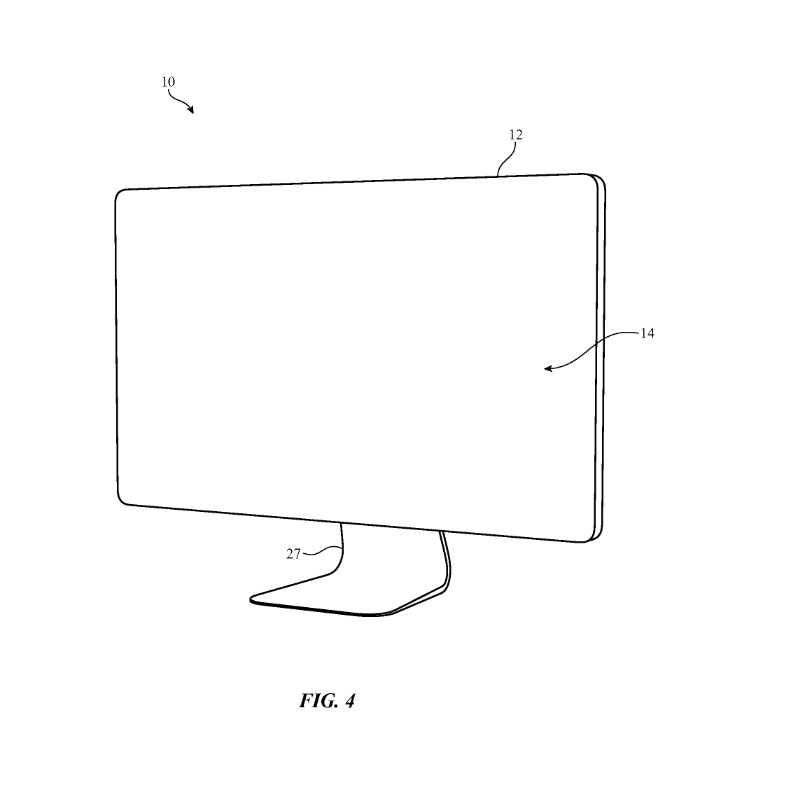

FIG. 4 shows an illustrative configuration for electronic device 10 in which device 10 is a computer display, a computer that has an integrated computer display, or a television. Display 14 is mounted on a front face of housing 12. With this type of arrangement, housing 12 for device 10 may be mounted on a wall or may have an optional structure such as support stand 27 to support device 10 on a flat surface such as a table top or desk.

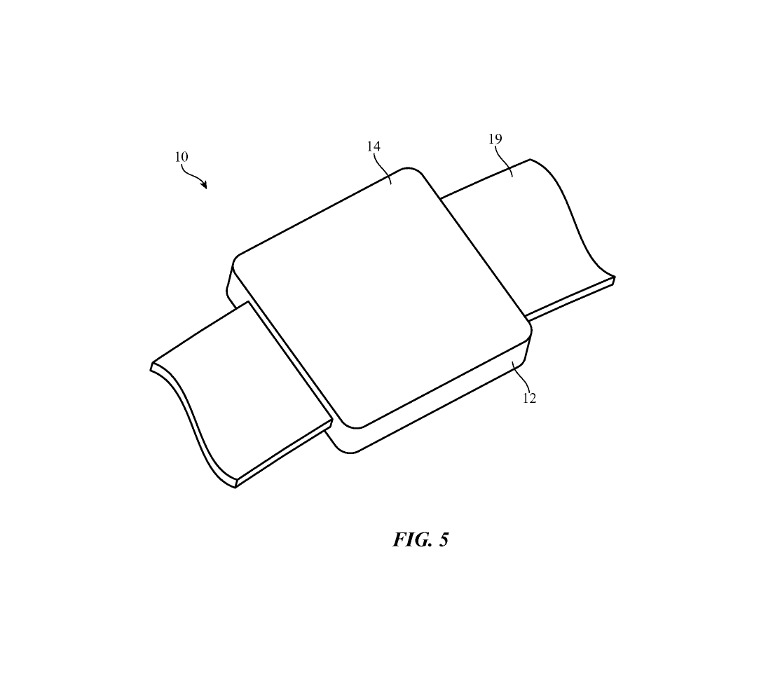

FIG. 5 shows an illustrative configuration for electronic device 10 in which device 10 is a wrist-watch device. Display 14 is mounted on a front face of housing 12. Electronic device 10 may have straps 19 for securing electronic device 10 to a user's wrist.

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may be a liquid crystal display, an organic light-emitting diode display, a plasma display, an electrophoretic display, an electrowetting display, a display using other types of display technology, or a display that includes display structures formed using more than one of these display technologies.

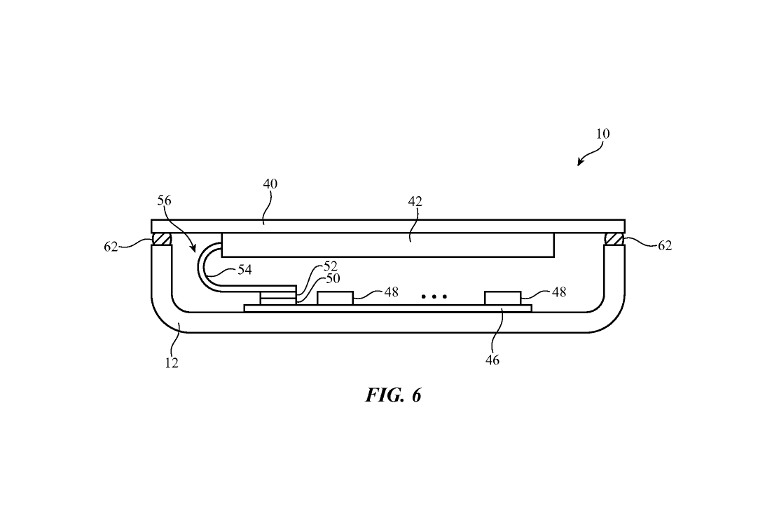

A cross-sectional side view of an illustrative electronic device of the type that may include structures that are attached using moisture and light curable adhesive is shown in FIG. 6. As shown in FIG. 6, display 14 of device 10 may be formed from a display module such as display module 42 mounted under a cover layer such as display cover layer 40 (as an example). Display 14 (display module 42) may be a liquid crystal display, an organic light-emitting diode display, a plasma display, an electrophoretic display, a display that is insensitive to touch, a touch sensitive display that incorporates and array of capacitive touch sensor electrodes or other touch sensor structures, or may be any other type of suitable display. Display cover layer 40 may be layer of clear glass, a transparent plastic member, a transparent crystalline member such as a sapphire layer, or other clear structure. Display layers such as the layers of display module 42 may be rigid and/or may be flexible (e.g., display 14 may be flexible).

Display 14 may be mounted to housing 12. Device 10 may have inner housing structures that provide additional structural support to device 10 and/or that serve as mounting platforms for printed circuits and other structures. Structural internal housing members may sometimes be referred to as housing structures and may be considered to form part of housing 12.

Electrical components 48 may be mounted within the interior of housing 12. Components 48 may be mounted to printed circuits such as printed circuit 46. Printed circuit 46 may be a rigid printed circuit board (e.g., a printed circuit board formed from fiberglass-filled epoxy or other rigid printed circuit board material) or may be a flexible printed circuit (e.g., printed circuit formed from a sheet of polyimide or other flexible polymer layer). Patterned conductive traces within printed circuit board 46 may be used to form signal paths between components 48. The conductive traces may be formed from conductive materials such as metal and/or carbon nanotubes.

If desired, components such as connectors may be mounted to printed circuit 46. As shown in FIG. 6, for example, a cable such as flexible printed circuit cable 54 may couple display module 42 to connector 52. Flexible printed circuit cable 54 (and other flexible substrates in device 10) may be formed from flexible polymer substrates such as polyimide layers and may have conductive traces formed from conductive material such as metal and/or carbon nanotubes. Connector 52 may mate with corresponding connector 50. Connectors 52 and 50 may be board-to-board connectors. Connector 52 may be soldered to flexible printed circuit 54 or may be attached to flexible printed circuit 54 using other techniques. Connector 50 may be soldered to printed circuit 46 or may be otherwise connected to printed circuit 46. When coupled as shown in FIG. 6, signals may pass from signal lines in flexible printed circuit 54 (e.g., display signals associated with operation of display 42) and signal lines in printed circuit 46.

To form a connection such as the signal path connection provided by flexible printed circuit 54, it may be desirable to bend flexible printed circuit 54 at one or more locations along the length of flexible printed circuit 54. In the example of FIG. 6, flexible printed circuit 54 has been bent once to form bend 56. Configurations in which flexible structures such as flexible printed circuit 54 are bent multiple times and/or in which a flexible substrate such as flexible printed circuit, flexible display, or flexible touch sensor are bent back and forth repeatedly during operation of a device with a hinge may also be used.

Housing 12 may be attached to cover glass 40 using moisture and light curable adhesive 62. Moisture and light curable adhesive 62 may be a liquid adhesive. Before curing occurs (e.g., before moisture and light curable adhesive 62 is exposed to moisture or light), moisture and light curable adhesive 62 may be referred to as a moisture and light curable adhesive “precursor,” “polymer precursor,” or “pre-polymer.” These terms refer to a mixture of monomers that is capable of further polymerization. Before curing, moisture and light curable adhesive precursor material may have limited cross linking. The moisture and light curable adhesive precursor material may become a liquid above a certain temperature. Often, it is desirable to apply adhesive in liquid form (e.g., a liquid adhesive). The moisture and light curable adhesive precursor material may therefore be dispensed as a liquid adhesive. After moisture and light curable adhesive precursor material 62 is dispensed, exposure to moisture or light may promote cross linking of the monomers in the liquid adhesive layer. Exposure to moisture or light will cure the adhesive and attach adjacent electronic device structures. The above example, in which the moisture and light curable adhesive is a liquid adhesive, is purely illustrative. Moisture and light curable adhesive 62 may be, for example, a pressure sensitive adhesive such as an adhesive tape.

Moisture and UV/visible light curable adhesive 62 may be a urethane based adhesive. Urethane based adhesives are designed to cure in the presence of ambient water. For example, a urethane based adhesive may cure in the presence of ambient humidity (e.g., 40%-70% relative humidity). Moisture and UV/visible light curable adhesive 62 may also be designed to cure in response to exposure to UV/visible light. Moisture and UV/visible light curable adhesive 62 may be designed to cure in response to exposure to any type of light. For example, moisture and light curable adhesive 62 may be cured by exposure to visible light, ultraviolet (UV) light, or infrared light.

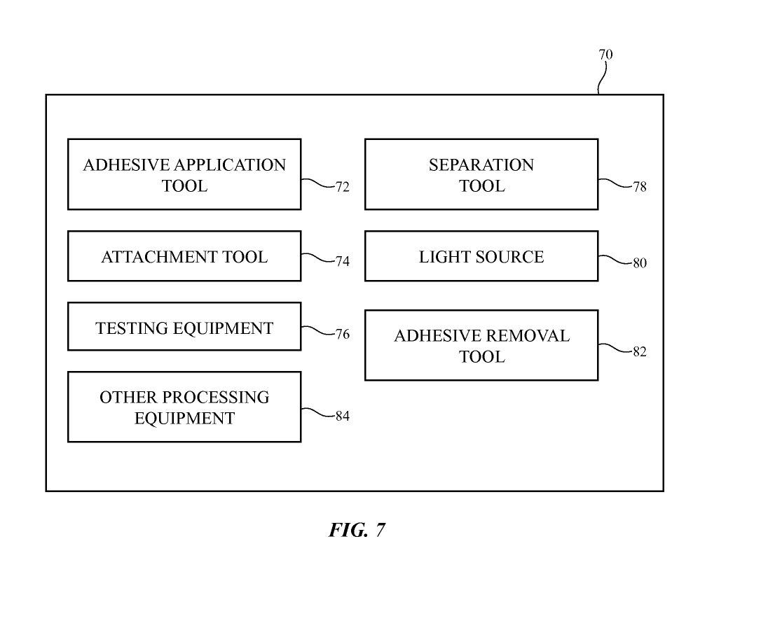

FIG. 7 is a diagram of an illustrative system for processing an electronic device that has electronic device structures attached with moisture and light curable adhesive. As shown, system 70 may include adhesive application tool 72, attachment tool 74, testing equipment 76, separation tool 78, light source 80, adhesive removal tool 82, and other processing equipment 84. System 70 may be used to dispense a moisture and light curable adhesive using adhesive application tool 72 then attach electronic device structures using attachment tool 74. After the electronic device structures are attached, the electronic device may undergo further processing and testing. The electronic device may be tested with testing equipment 76. Testing equipment 76 may determine that electronic device 10 needs to be reworked. In this scenario, separation tool 78 may be used to separate the electronic device structures attached by the moisture and light curable adhesive. The moisture and light curable adhesive may be exposed to light from light source 80. An adhesive removal tool 82 may be used to remove the remaining moisture and light curable adhesive from the electronic device structures. The electronic device may then be reworked, and the electronic device structures salvaged for later use.

Adhesive application tool 72 may be used to dispense moisture and light curable adhesive onto the surface of an electronic device structure. Adhesive application tool 72 may include equipment for dispensing moisture and light curable adhesive precursor material onto the surface of an electronic device structure such as housing 12 or cover glass 40 shown in FIG. 6. Tool 72 may, for example, use a robotically or manually controlled liquid adhesive dispensing valve such as a slit valve or other valve to dispense liquid adhesive on the surface of an electronic device structure. Liquid adhesive may also be dispensed on the surface of an electronic device structure using spraying, screen printing, pad printing, or other liquid adhesive application techniques. The adhesive precursor material may be heated to reduce its viscosity before, during or after application. Liquid adhesive heating operations may be performed on the liquid adhesive before applying the adhesive to an electronic device structure, during the process of dispensing liquid adhesive onto an electronic device structure, or after applying the liquid adhesive to the surface of an electronic device structure. Heating the moisture and light curable adhesive precursor material may ensure that moisture and light curable adhesive precursor material remains in liquid form until desired. Adhesive application tool 72 may be used to apply adhesive to a first electronic device structure, a second electronic device structure, or multiple electronic device structures.

Attachment tool 74 may be used to attach two electronic device structures together. Tool 74 may, for example, use a robotically or manually controlled positioner to place first and second electronic device structures adjacent to each other and connected by adhesive. Alternatively, the structures may be manually placed together. Attachment tool 74 may include clamping structures that clamp first and second electronic device structures together until the previously dispensed adhesive is cured for long enough to maintain the bond between the two electronic device structures. The clamping structures may include one or more computer controlled clamping structures that apply pressure to the electronic device structures. The clamping structures may apply a calibrated amount of pressure to the electronic device structures. If desired, a single attachment structure may place a first electronic device structure adjacent a second electronic device structure then apply pressure to the structures for clamping (e.g., a single structure may be used for placing and clamping). Alternatively, separate structures may be used for positioning the electronic device structures and clamping the electronic device structures. For example, a computer controlled positioner may be used to place a first electronic device structure on a second electronic device structure. The computer controlled positioner may then place the attached first and second electronic device structures on a conveyor belt. The conveyor belt may convey the first and second electronic device structures to a separate clamping structure that clamps the first and second electronic device structures together. Any of these steps may be performed manually if desired. For example, a worker may place first and second electronic device structures together, clamp the structures, etc.

System 70 may also include testing equipment 76 for testing the electronic device. Testing equipment 76 may, for example, include equipment for testing input/output components in an electronic device. Testing equipment 76 may include equipment for testing wireless communications circuitry in an electronic device. Testing equipment 76 may include one or more test stations. Test equipment at each test station may be used to perform an associated test on a device. For example, one test station may have equipment for testing a display in the device. Another test station may have equipment for testing an audio component in the device. Yet another test station may have equipment for testing light sensors in the device. Yet another test station may have equipment for testing wireless communications circuitry in the device.

Automated equipment may be used in loading and unloading devices under test, in conveying devices under test between test stations, and in performing tests and maintaining a database of test results. For example, an electronic device under test may be transported to an electromagnetically shielded test enclosure with a conveyor belt. A computer-controlled loading structure may move the electronic device under test from the conveyor belt to the electromagnetically shielded test enclosure. Once in the electromagnetically shielded test enclosure, the wireless communications circuitry of the device may be tested. If desired, a manufacturing facility may include test areas for performing different types of tests. For example, system 70 may include a test area for performing longer-duration testing (e.g., tests that may take one or more hours such as battery testing, extreme temperature testing, etc.). The aforementioned examples of test equipment are not meant to be limiting in any way. In general, test equipment 76 may include any components that directly or indirectly assist in testing an electronic device.

Separation tool 78 may be included in system 70. Separation tool 78 may be used to separate electronic device structures that are attached with adhesive. Separation tool may include computer-controlled equipment that is designed to separate two electronic device structures. For example, separation tool 78 may be used to separate a cover glass from an electronic device housing. Separation tool may separate electronic device structures using any desired methods. In certain embodiments, separation tool 78 may be use vacuums to pull apart two electronic device structures. Separation tool 78 may alternatively use equipment that applies pressure to portions of the electronic device structures to separate the structures. In general, any equipment capable of separating two electronic device structures may be used. If desired, any or all steps in separating the structures may be performed manually.

Light source 80 may be used to expose moisture and light curable adhesive to light. Light source 80 may include a light source such as a lamp, light-emitting diode, or laser that emits light. The emitted light may be ultraviolet light, visible light, or other light that induces cross-linking in the liquid adhesive. Light source 80 may to apply light to moisture and light curable adhesive on an electronic device structure using any desired method. For example, a computer-controlled or manually-controlled positioner may be used to apply light to moisture and light curable adhesive. In some cases, the light may need to be precisely applied to the adhesive as certain components in the electronic device may be damaged if exposed to certain types of light. For example, exposure to ultraviolet light may damage a battery in the electrical device or discolor other components in the electronic device. To avoid these problems, a light guide may be used to precisely apply the light to only the moisture and light curable adhesive. A mask may also be used to protect portions of the electronic device from being exposed to the light (e.g., a mask may be placed on the electronic device that has openings only over the areas with moisture and light curable adhesive present).

System 70 also includes adhesive removal tool 82. Adhesive removal tool 82 may be used to remove moisture and light curable adhesive from electronic device structures. The adhesive removal tool may include computer or manually operated equipment designed to aid in removing adhesive from electronic device structures. If desired, the adhesive may be removed manually. For example, a worker may physically pull off the adhesive from an electronic device structure.

Finally, system 70 may include other processing equipment 84. This equipment may be used to install electronic components in an electronic device. For example, processing equipment 84 may be used to install printed circuit 46, electronic components 48, and display module 42 in electronic device 10. Other processing equipment 84 may include any equipment involved in the assembly or processing of electronic device 10.

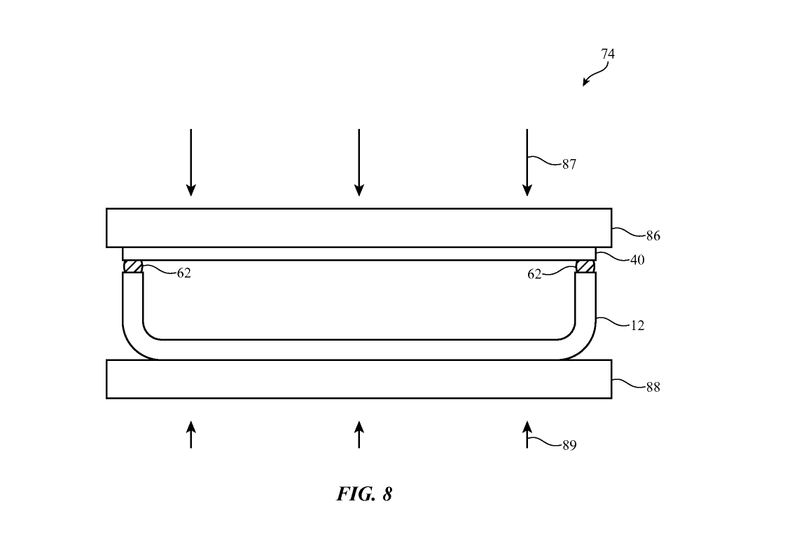

FIG. 8 is a cross-sectional side view of an illustrative attachment tool for attaching electronic device structures using moisture and light curable adhesive. As shown, attachment tool 74 may include clamping structures 86 and 88. Clamping structures 86 and 88 may be configured to clamp housing 12 and cover glass 40 such that housing 12 and cover glass 40 are attached by moisture and light curable adhesive 62. Clamping structure 86 may push cover glass 40 in a first direction 87, while clamping structure 88 may push housing 12 in a second direction 89. Directions 87 and 89 may be opposite each other such that cover glass 40 and housing 12 are pressed firmly together. If desired, only one clamping structure may be used. For example, a single clamp may push cover glass 40 in direction 87 and housing 12 in direction 89. Clamping structure 86 may be used to transport and place cover glass 40 on housing 12. Alternatively, a separate piece of equipment many be used to position cover glass 40 on housing 12. The use of cover glass 40 and housing 12 in FIG. 8 is purely illustrative, and attachment tool 74 may be used to attach any two electronic device structures.

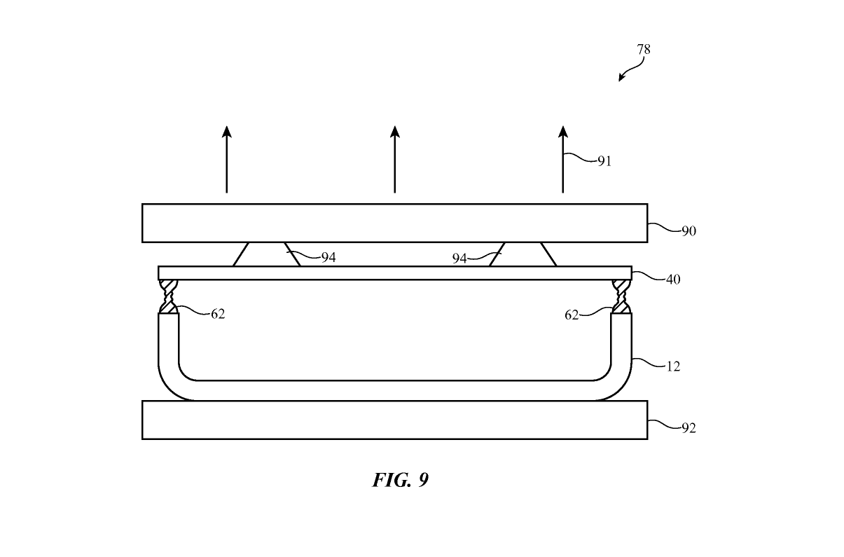

FIG. 9 is a cross-sectional side view of an illustrative separation tool for separating electronic device structures. Separation tool 78 may include separation structures 90 and 92. Separation structures 90 and 92 may both be used to draw vacuums and secure respective electronic device structures. For example, separation structure 90 may use a vacuum and suction cups 94 to secure cover glass 40. Separation structure 92 may use a vacuum to secure housing 12. Once the separation structures have drawn a vacuum to secure the electronic device components, one or both of the separation structures may move apart to separate the components.

In FIG. 9, separation structure 90 is shown as moving in direction 91, thus pulling cover glass 40 away from housing 12. Separation structure 92 may remain stationary while cover glass 40 is pulled away. Alternatively, separation structure 90 may remain stationary while separation structure 92 pulls housing 12 away from cover glass 40. In yet another embodiment, both separation structures 90 and 92 may be moved to separate the device components. The use of cover glass 40 and housing 12 in FIG. 9 is purely illustrative, and separation tool 78 may be used to separate any two electronic device structures.

Separation structures 90 and 92 are depicted as separate structures in FIG. 9. This example is purely illustrative. Separation structures may be, for example, attached by a hinge structure. Separation structure 92 may remain stationary while separation structure 90 swings open at the hinge to pull apart electronic device components.

Separation structures 90 and 92 may use any desired method to draw a vacuum on an electronic device component. In certain embodiments, one or both separation structures may include suction cups such as suction cups 94 that form a seal on an electronic component and aid in pulling the electronic components. In another embodiment, separation structures may include a vacuum with a plurality of holes for pulling on the electronic device structure. The vacuum may be covered by a thin elastomeric material to avoid damaging the electronic device structures during separation.

Separation tool 78 may heat moisture and light curable adhesive 62 while separating two electronic device components. In certain embodiments, separation structures 90 and 92 may locally heat moisture and light curable adhesive 62. For example, separation structures 90 and 92 may include a conductive material (e.g., metal) that is designed to overlap and heat moisture and light curable adhesive 62. In alternate embodiments, separation tool 78 may operate in a temperature-controlled environment such as an oven. Heating moisture and light curable adhesive 62 may soften the adhesive and make it easier to pull apart cover glass 40 and housing 12. A heat gun or other heating mechanism may also be used to heat moisture and light curable adhesive 62.

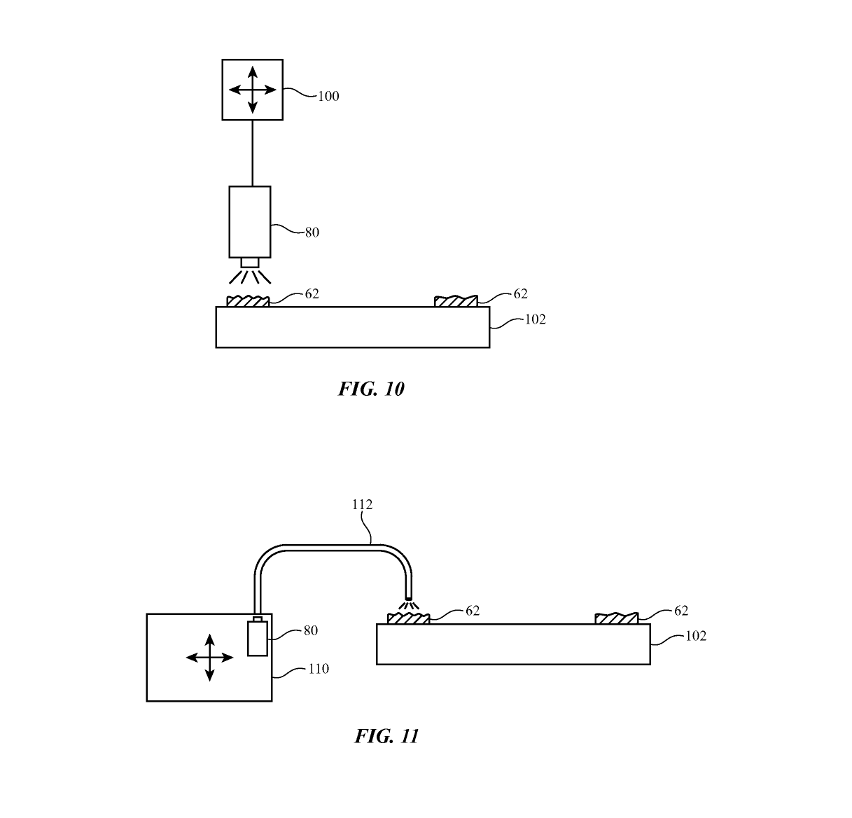

FIG. 10 is a side view of an illustrative light source with a computer-controlled positioner for exposing moisture and light curable adhesive on an electronic device structure to light. As shown in FIG. 10, an electronic device structure 102 may have residual moisture and light curable adhesive 62 on a surface of the structure. Light source 80 may be attached to a computer-controlled positioner 100. The computer-controlled positioner 100 may move the light source along a path that corresponds to the location of the adhesive. Moisture and light curable adhesive 62 may be deposited on surface 102 in a known pattern. Computer-controlled positioner 100 may therefore move light source 80 along the known pattern to ensure that all of the adhesive is exposed to the light source. Sensors such as a camera, laser-based position sensors, or other sensors may be used to provide the computer-controlled positioner with real-time feedback so that light source 80 may be accurately positioned above moisture and light curable adhesive 62. If desired, light source 80 may be positioned manually instead of using computer-controlled positioner 100.

FIG. 11 is a side view of an illustrative light source with a light guide for exposing moisture and light curable adhesive on an electronic device structure to light. Electronic device structure 102 may have residual moisture and light curable adhesive 62 on a surface of the structure. Light source 80 may be positioned on a computer-controlled positioner 110. Light guide 112 may guide light from light source 80 to moisture and light curable adhesive 62. Computer-controlled positioner 110 may move light source 80 while light guide 112 remains stationary. In an alternate embodiment, computer-controlled positioner 110 may move light guide 112 while light source 80 remains stationary. Sensors such as a camera, laser-based position sensors, or other sensors may be used to provide the computer-controlled positioner with real-time feedback so that light guide 112 may be accurately positioned above moisture and light curable adhesive 62. If desired, one or both of light source 80 and light guide 112 may be positioned manually instead of using computer-controlled positioner 110.

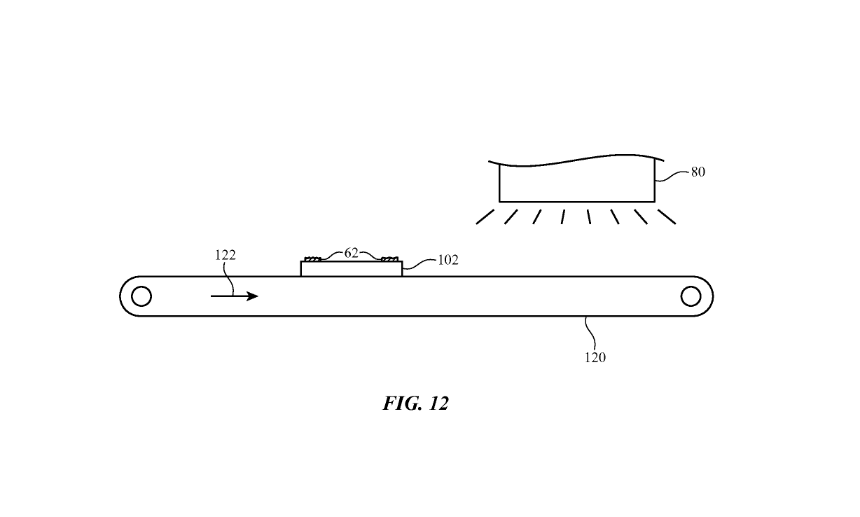

FIG. 12 is a side view of an illustrative light source for exposing moisture and light curable adhesive on an electronic device structure to light. As shown in FIG. 12, light source 80 may be positioned above a conveyor belt 120. Conveyor belt 120 may transport structures such as electronic device structure 102 in direction 122 towards light source 80. As electronic device structure 102 passes under light source 80, moisture and light curable adhesive 62 will be exposed to light from light source 80, curing the adhesive. This is a less precise method of exposing electronic device structure 102 to light, as the entire surface of electronic device structure 102 will be exposed (not just the portions with residual moisture and light curable adhesive 62). To prevent unnecessary exposure to electronic device structure 102, a mask may be provided that blocks some of the light from light source 80 and selectively applies light to the moisture and light curable adhesive.

The light sources in FIGS. 10-12 are used to cure moisture and light curing adhesive 62. In certain embodiments, light source 80 may be used in tandem with a heat source for promoting cross-linking in the adhesive. In another embodiment, light source 80 may also be used in tandem with equipment for dispensing a chemical catalyst to promote curing of the liquid adhesive. These additional curing techniques may depend on the properties of the specific adhesive being used. In general, any methods of promoting curing adhesive 62 may be used in conjunction with light source 80.

Electronic device structure 102 in FIGS. 10-12 may be any desired structure in an electronic device. In certain embodiments, electronic device structure 102 may be an electronic device housing such as housing 12 or a cover glass such as cover glass 40.

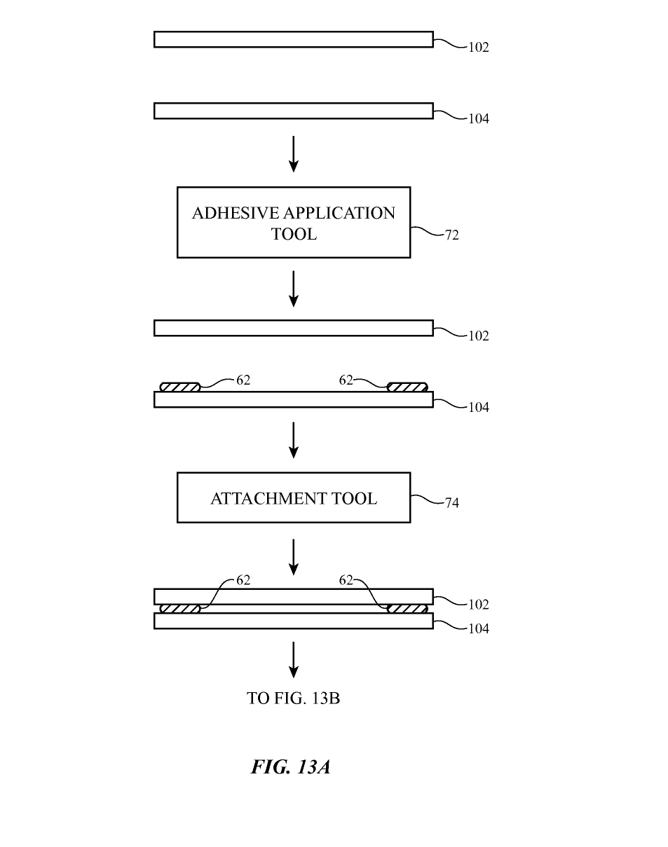

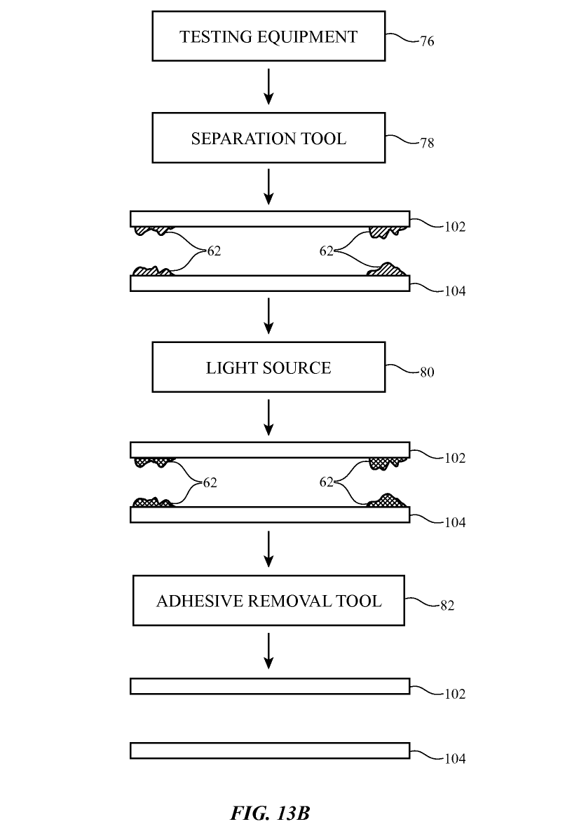

FIGS. 13A and 13B are diagrams showing how an electronic device with electronic device structures attached using moisture and light curable adhesive may be processed. As shown in FIG. 13A, electronic device structures 102 and 104 may be provided. Electronic device structures 102 and 104 may be any desired structures in an electronic device. In certain embodiments, electronic device structures 102 and 104 may be an electronic device housing and a cover glass, respectively. Adhesive application tool 72 may be used to apply moisture and light curable adhesive 62 to an electronic device structure. In FIG. 13A, moisture and light curable adhesive 62 is depicted as being applied only to electronic device structure 104. This example is purely illustrative, and moisture and light curable adhesive 62 may be applied to only electronic device structure 104, only electronic device structure 102, or both electronic device structures 102 and 104.

Attachment tool 74 may be used to attach electronic device structure 102 to electronic device structure 104. After the adhesive has been dispensed and the device structures have been attached, moisture and light curable adhesive 62 may be partially cured due to exposure to ambient moisture. However, moisture and light curable adhesive 62 may not be fully cured.

As shown in FIG. 13B, electronic device structures 102 and 104 may be tested using testing equipment 76. During testing, it may be determined that electronic device structures 102 and 104 need to be separated for rework. Separation tool 78 may be used to separate electronic device structures 102 and 104.

After electronic devices structures 102 and 104 have been separated, residual moisture and light curable adhesive may remain on the surfaces of the electronic device structures. FIG. 13B shows moisture and light curable adhesive 62 on both electronic device structures 102 and 104 after separation. This example is purely illustrative. In some cases, all of the residual moisture and light curable adhesive may be on only one of the electronic device structures. In other cases, most of the residual moisture and light curable adhesive may be on one electronic device structure with the remainder on the other electronic device structure. In yet another scenario, approximately half of the residual moisture and light curable adhesive may remain on each electronic device component after separation. After the electronic device components are separated and before the electronic device components have been exposed to light source 80, residual moisture and light curable adhesive 62 may still be only partially cured.

After separation, moisture and light curable adhesive 62 on electronic device structures 102 and 104 may be exposed to light source 80. Light source 80 may be positioned in an arrangement of the type shown in FIG. 10, FIG. 11, FIG. 12, or another desired arrangement. After exposure to light source 80, the moisture and light curable adhesive may be fully cured. Once fully cured, the moisture and light curable adhesive may be able to be removed without leaving residual adhesive on electronic device structures 102 and 104.

Adhesive removal tool 82 may be used to remove the cured moisture and light curable adhesive 62. After removal, electronic device structures 102 and 104 may be free of residual adhesive. Electronic device structures 102 and 104 may subsequently be reused in an electronic device.

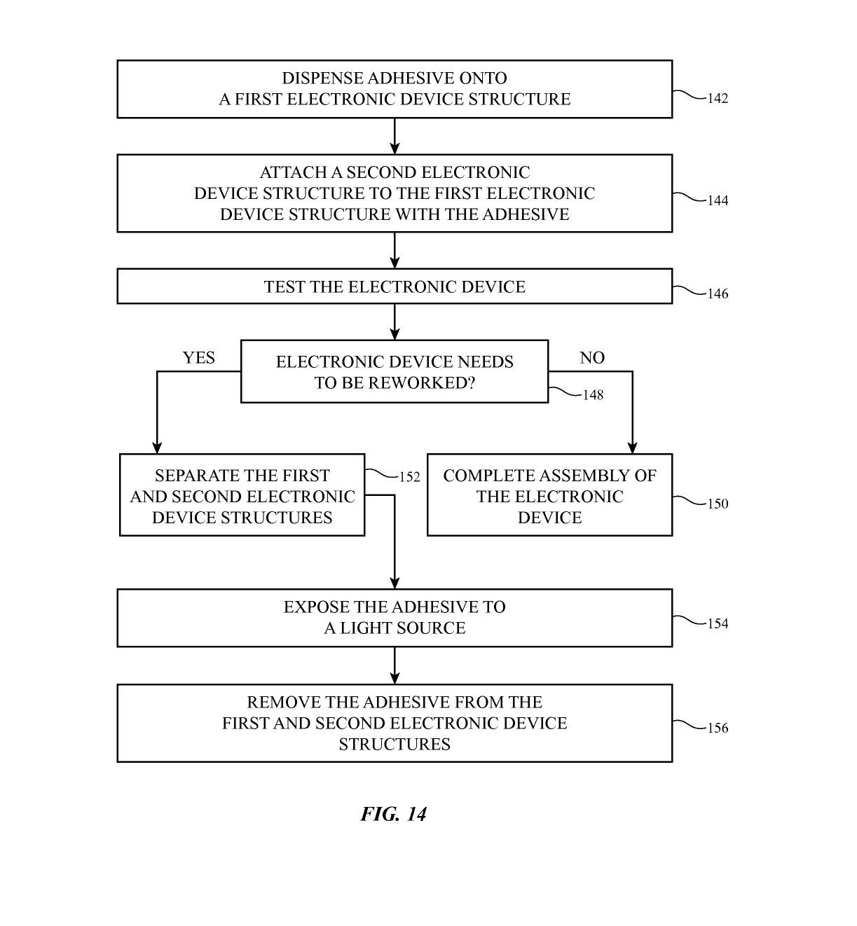

FIG. 14 is a flowchart showing illustrative steps involved with processing an electronic device that includes electronic device structures attached with moisture and light curable adhesive. At step 142, adhesive may be dispensed onto at least a first electronic device structure. If desired, adhesive may be dispensed onto multiple electronic device structures that are intended to be attached. Adhesive application tool 72 may be used to dispense adhesive onto the electronic device structure.

At step 144, a second electronic device structure may be attached to the first electronic device structure. Attachment tool 74 may be used to attach the first and second electronic device structures. In certain embodiments, the first and second electronic devices structures may be an electronic device housing (e.g., housing 12) and a cover glass (e.g., cover glass 40). As shown in FIG. 6, cover glass 40 and housing 12 may at least partially enclose printed circuit 46, electrical components 48, and display module 42.

The electronic device may then be tested at step 146. Any desired portion of the electronic device may be tested with testing equipment 76. For example, the functionality of electrical components 48 and display module 42 may be tested. Input/output components such as a camera, speaker, microphone, or ambient light sensor may be tested. The electronic device's wireless communications circuitry may be tested. Any number of tests may be performed to assess the performance and quality of the electronic device.

At step 148, testing equipment 76 may determine whether the electronic device needs to be reworked. The electronic device may need to be reworked if the device fails one or more tests. It should be noted that an electronic device may fail a test but still not need to be reworked (e.g., the faulty component may be fixed without separating the cover glass from the housing). In these scenarios, the faulty component may be fixed or replaced and the electronic device may be assembled at step 150. Some electronic devices may pass all of the tests performed by testing equipment 76. Assembly of these devices may also be completed at step 150. Electronic devices that fail a test may need to be reworked. The housing and cover glass of these components may be separated at step 152. Separation tool 78 may be used to separate the first and second electronic device structures. Once cover glass 40 has been removed from housing 12, electrical components 48 and other internal components may be accessible. The problem component may then be fixed or replaced.

At step 154, any remaining moisture and light curable adhesive on the first and second electronic device structures may be exposed to a light source. The exposure to light source 80 may cure the moisture and light curable adhesive. Subsequently, the adhesive may be removed from the first and second electronic device structures at step 156. The first and second electronic device structures may then be available for use in the reworked electronic device or another electronic device. For example, after the electronic device is reworked the process may return to step 142 and cover glass 40 may be attached to housing 12 with freshly dispensed moisture and light curable adhesive.

The foregoing is merely illustrative of the principles of this invention and various modifications can be made by those skilled in the art without departing from the scope and spirit of the invention.

1. A method of processing an electronic device with first and second electronic device structures attached together with adhesive, the method comprising:
separating the first electronic device structure from the second electronic device structure;
after separating the first and second electronic device structures, exposing the adhesive to light to cure the adhesive, wherein exposing the adhesive to light to cure the adhesive increases an adhesive strength of the adhesive; and
removing the adhesive from the first and second electronic device structures.

2. The method defined in claim 1, further comprising:
before separating the first electronic device structure from the second electronic device structure, dispensing adhesive onto the first electronic device structure; and
attaching the second electronic device structure to the first electronic device structure with the adhesive.

3. The method defined in claim 2, further comprising:
after attaching the second electronic device structure to the first electronic device structure with the adhesive and before separating the first electronic device structure from the second electronic device structure, testing the electronic device.

4. The method defined in claim 3, wherein testing the electronic device comprises determining that the electronic device needs to be reworked, and wherein separating the first electronic device structure from the second electronic device structure comprises separating the first electronic device structure from the second electronic device structure in response to determining that the electronic device needs to be reworked.

5. The method defined in claim 3, further comprising:
after attaching the second electronic device structure to the first electronic device structure with the adhesive and before testing the electronic device, at least partially curing the adhesive.

6. The method defined in claim 2, wherein dispensing adhesive onto the first electronic device structure comprises dispensing a moisture and ultraviolet light curable adhesive.

7. The method defined in claim 1, wherein exposing the adhesive to light to cure the adhesive comprises exposing the adhesive to ultraviolet light to cure the adhesive.

8. The method defined in claim 1, wherein the first electronic device structure comprises an electronic device housing structure, and wherein the second electronic device structure comprises a cover glass.

9-20. (canceled)

21. A method of processing an electronic device with first and second electronic device structures attached together with adhesive, the method comprising:
separating the first electronic device structure from the second electronic device structure;
after separating the first and second electronic device structures, exposing the adhesive to light to cure the adhesive, wherein exposing the adhesive to light to cure the adhesive promotes cross linking of monomers in the adhesive; and
removing the adhesive from the first and second electronic device structures.

22. A method of processing an electronic device with first and second electronic device structures, the method comprising:
attaching the second electronic device structure to the first electronic device structure with adhesive;
after attaching the second electronic device structure to the first electronic device structure with the adhesive, at least partially curing the adhesive;
after at least partially curing the adhesive, testing the electronic device;
after testing the electronic device, separating the first electronic device structure from the second electronic device structure;
after separating the first and second electronic device structures, exposing the adhesive to light to increase an adhesive strength of the adhesive while the first and second electronic device structures are separated; and
while the first and second electronic device structures are separated, removing the adhesive from the first and second electronic device structures.

23. The method defined in claim 22, wherein testing the electronic device comprises determining that the electronic device needs to be reworked, and wherein separating the first electronic device structure from the second electronic device structure comprises separating the first electronic device structure from the second electronic device structure in response to determining that the electronic device needs to be reworked.
